(19) United States
(12) Patent Application Publication
(10) Pub. No.: US 2003/0027490 A1
(43) Pub. Date: Feb. 6, 2003

(54) Beatrice beehive

(76) Inventor: Thomas Wilson Wilkinson, Suffield, CT (US)

Correspondence Address: Thomas W. Wilkinson, 670 East Street South, Suffield, CT, 06078, US

(21) Appl. No.: 09/923,121

(22) Filed: Aug. 6, 2001

(51) Int. Cl. A01K 47/00

(52) U.S. Cl. 449/38

(57) ABSTRACT

A beehive for general use is disclosed to be fabricated such that it has six sides to the main body. The frames, which are supported from below, also have six sides. The hive has two of its' sides attached with hinges and a rear drawer type access port is provided.

### CITED REFERENCES

Disclosure document NO: 471724

### OTHER PUBLICATIONS

“The How-to-do-it book of Beekeeping”, Richard Taylor, fifth edition, 1998, pgs63-64, publisher: Linden Books

“The Dance Language and Orientation of Bees”, Karl von Frisch, 1993, pg 293publisher: Harvard University Press

“Toward Saving the Honeybee”, Gunther Hauk, 2001, publisher: Biodynamic Farming and Gardening Association

### BACKGROUND OF THE INVENTION

Most people are familiar with the rectangular shaped ‘Langstroth’ beehive. It was named for an American pastor, Lorenzo Langstroth (1810-1895) who created two key aspects of the design in 1851. This rectangular shape differed from previous shapes by the incorporating into its' architecture, many air gaps called ‘bee spaces’. In addition, Langstroth is credited with the idea of using wooden frames, placed into the hive, surrounded by the ‘bee space’.

The ‘bee space’ is about ⅜ of an inch. This is the space needed for a bee to crawl through. The significance of this ‘space’ is; anywhere the air gaps inside a hive are less than or greater than ⅜″, the bees will try to fill these spaces with comb or a sticky glue like substance they make, called propolis. The ‘bee space’, in conjunction with wooden frames (being ⅜″ from all surfaces), allows one to fabricate a hive so frames can easily be removed for inspection or honey extraction and one is not prone to destroy a section of the hive in doing so. In pre Langstroth days, less honey could be taken due to damage occurring because of the more fragile orientation of the combs inside the hive.

Consequently, incorporating the ‘bee space’ with wooden frames into hive building allowed the idea of large-scale commercial production of honey to become a reality. Bee keeping developed into a profitable commercial business at the end of the 19^{th} century which led to the tampering with the reproductive cycle of the bee for the purpose of achieving maximum honey production. The artificial rearing of queens and other new practices arose. The natural way of new queens arising and the old queen leaving via swarms was discouraged. A method to keep the queen from moving freely throughout the hive was developed along with other new influences, such as comb foundations, support wires for the combs, plastic comb foundations etc. From a business perspective, you would want to control the swarms, preventing your honey producers from leaving the hive to find a new home somewhere in the woods on their own.

It seems there are half a dozen or so diseases and a few parasites, working against the best interests of the honeybee. Of these, the varroa mite eats into the abdomen of the honeybee and the tracheal mite destroys their breathing tubes. These parasites have always lived off the bee race common in the Asian parts of the world, seemingly for a long time. The varroa mite has spread from this part of the world and was introduced to America, in 1980. The American honeybee is unable to coexist with the varroa mite. This is most likely due to our western manipulation of the honeybees' life cycle to obtain maximum honey production. Most seem to agree, the American honeybee is now unable to survive without human intervention to reduce the mite population. Mite elimination is accomplished today by adding various chemicals to the hive at certain times. Evidently, this will only be effective for so long before the mites who have a resistance to these chemicals reproduce. A recent web source states, “Varroa resistance to fluvalinate (Apistan) is already known to have developed in Italy, and has slowly made its way into parts of Switzerland and France”. Bee genetic identification programs are currently underway at many research centers and universities. Apparently a new type of search is beginning. Many now feel, the task is to genetically create or find a honeybee that can survive without adding chemicals to the hive.

### SUMMARY OF THE INVENTION

The ‘Beatrice Beehive’ is a new design for the housing of honeybees. In general the hive can hold any number of frames. Each of the individual frames are six sided. Two of the hive body's sides have hinges on them for the purpose of allowing the beekeeper to access the frames. The beekeeper needs to access the frames for various reasons. Two of these reasons are; to check the ‘health’ of the hive and to remove the frames for extraction of honey.

The hive body essentially has the shape of a very large six-sided cylinder. The opening for the bees is located on one end of the hive. Each end of the hive body is terminated by a flat piece of wood. The frames rest within the hive body and are supported from below by two of its' lower sides. In the Langstroth style of hive the frames hang from the top portion of each individual frame. In this style of hive, when a new colony of bees is put into the hive it is quite possible that not all of the frames would be installed. In this case a divider board (having the same size as one of the frames) would be installed to essentially close off the rest of the hive from the bees. As time passes and the bees begin to outgrow their initial group of frames the beekeeper may then slide this divider board away from the existing frames and add more frames as required.

The hive has a small drawer built into the rear side for the monitoring of the mite population. The hive has an access port in the top cover.

### BRIEF DESCRIPTION OF THE DRAWINGS

FIG. 1: Hive body.

FIG 1A: Front of hive.

FIG. 2: Frame.

FIG. 3: Detail of top 3 pieces of the frame.

FIG. 4: Detail of bottom 2 lower pieces of the frame.

FIG. 5: Detail of the bottom section of the frame.

FIG. 6: Detail of rear of hive, with drawer.

FIG. 7: Photograph of frame with comb built by bees.

### DETAILED DESCRIPTION OF THE PREFERRED EMBODIMENT

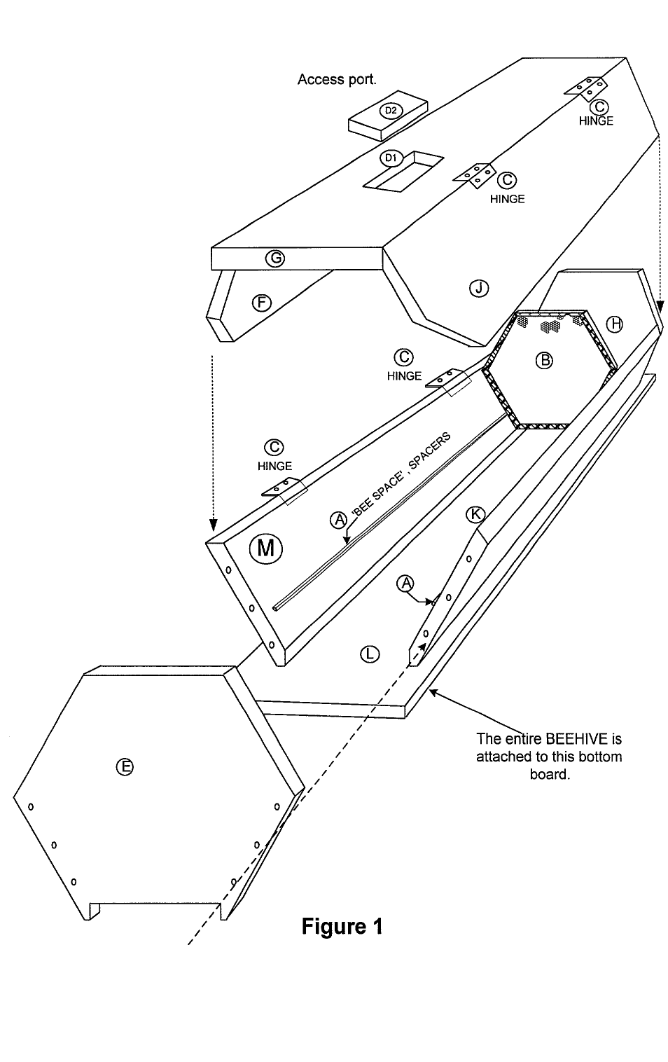

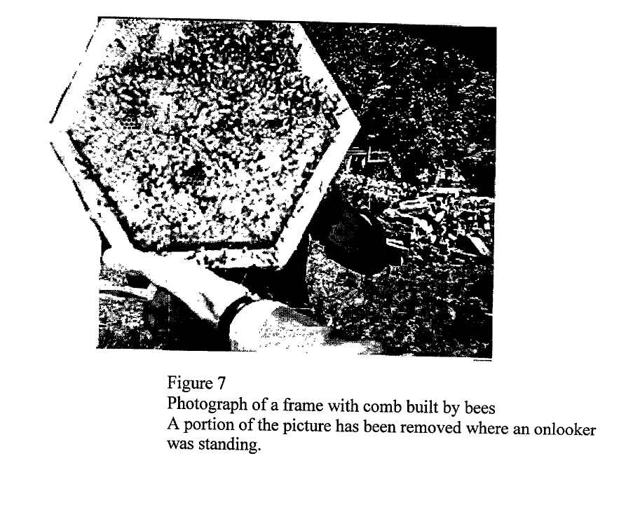

Refer to FIGS. 1 through 7. One end of the hive has an opening, which the bees enter and exit from. The end with this opening in it also has an overhang for shade, rain and wind protection.

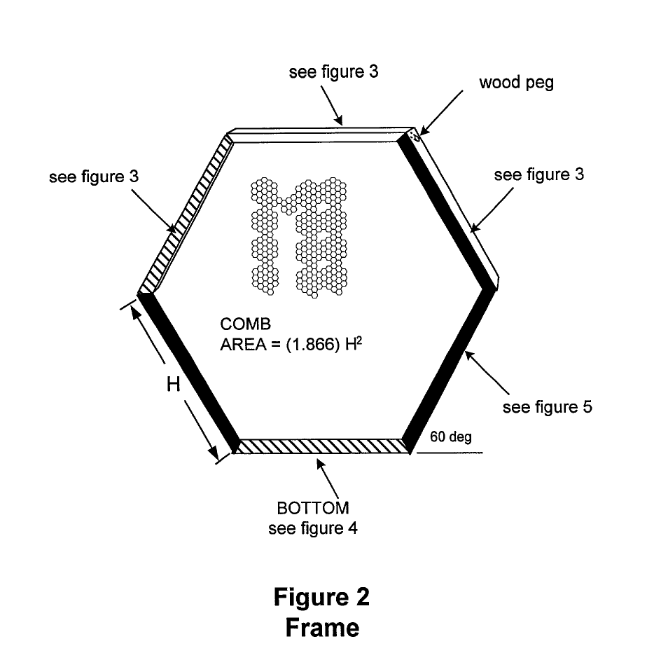

Each frame is comprised of six sides. The top three pieces (see FIG. 3) have a narrow groove cut into the underside of them for the insertion of comb. A full sheet of foundation can be inserted or a portion of a sheet. If only a portion of man-made comb is inserted, the bees will add to this and draw it down to fill the frame on their own. It is important for the bees to be able to build some of their own comb and not to use too much of the man made comb. The size of the comb cell, made by the worker bee, determines whether the queen bee will place a female or male egg in it. The fossil records of three European races of honeybees can be traced back as far as the last Ice Age, approximately 10,000 years. Therefore since the last Ice Age up until the early 20^{th} century, this decision making process concerning the gender of the bee egg has not been interfered with.

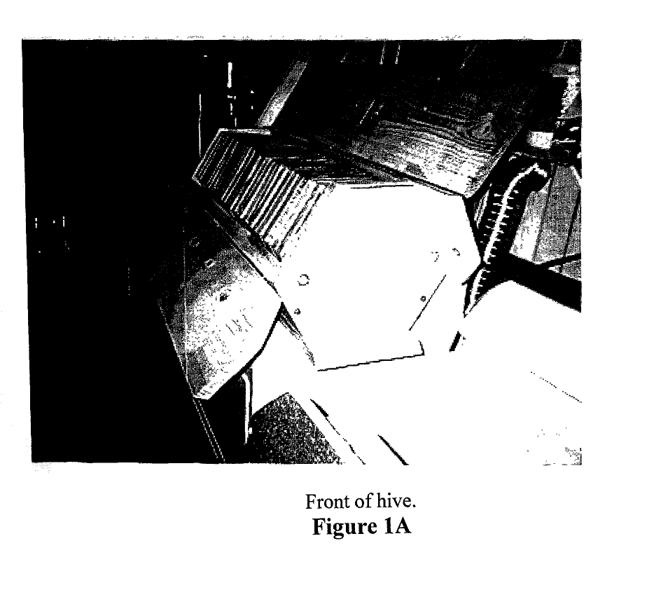

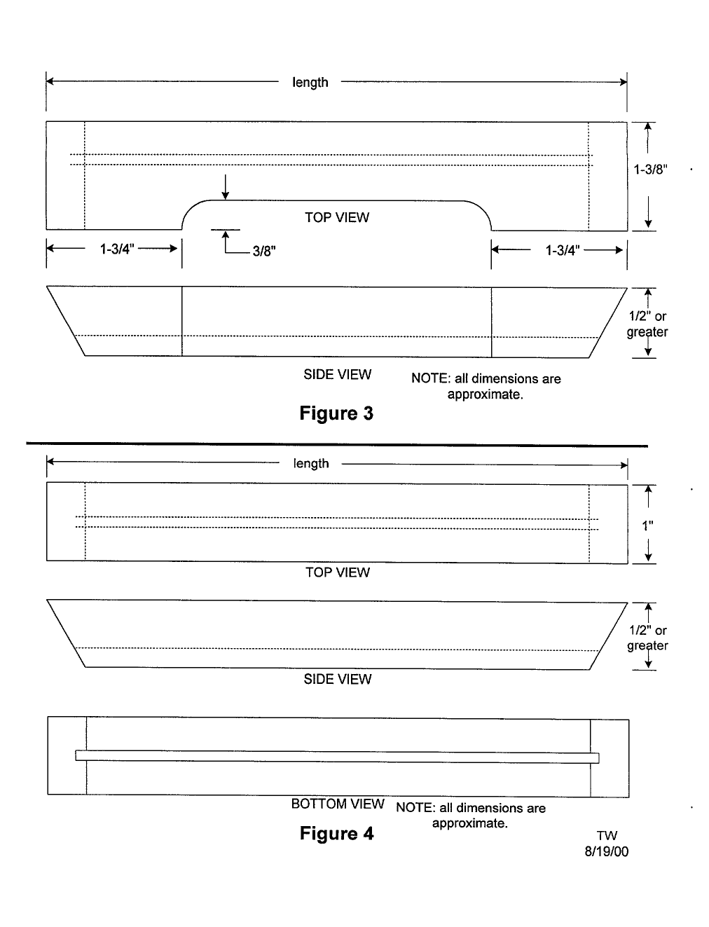

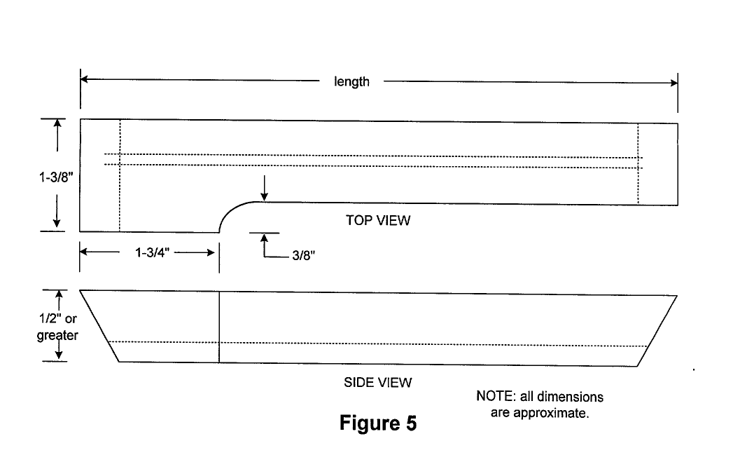

The frames are composed of 6 pieces (see FIG. 2) each piece is fastened to its' adjoining piece. It would be best to use wood for the frames although other materials could be used. The bottom piece of the frame is shown in FIG. 4. The two pieces (see FIG. 5), which connect to the bottom piece of the frame, are similar to the top pieces on one end and similar to the bottom piece of the frame on the other end. The bottoms of the frames when inserted into the hive do not touch each other. Only from the middle of the frame to the top of the frame is there any connection from frame to frame. This provides the necessary vertical stability for the frames and also allows the bees more room at the bottom of the hive.

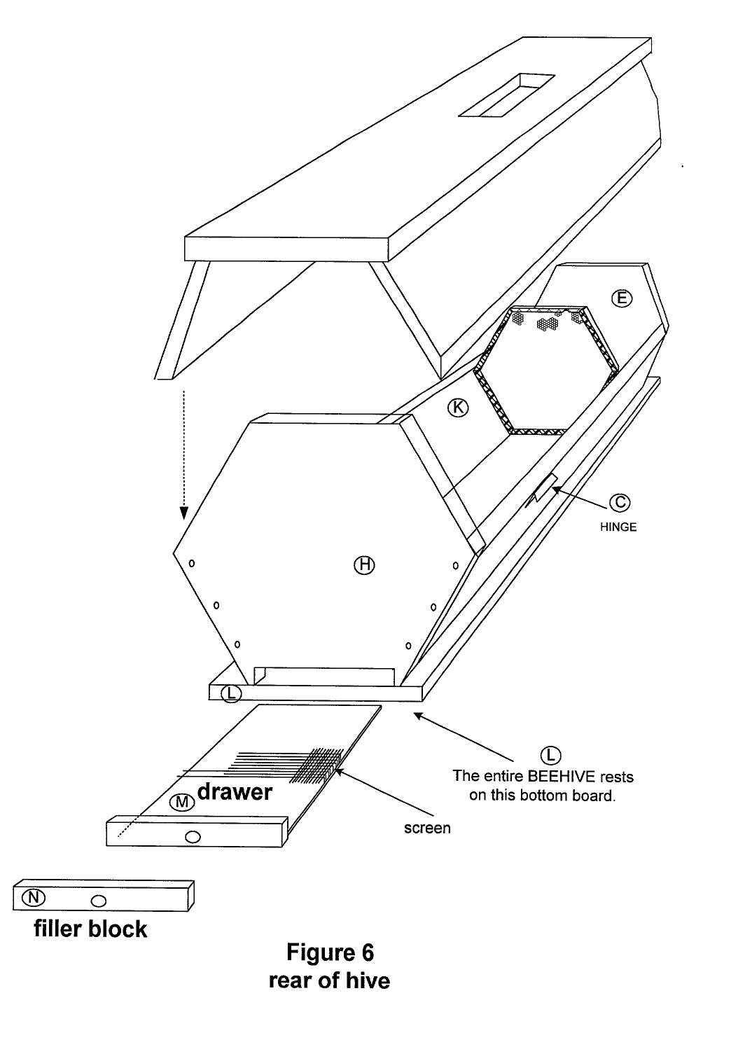

The rear of the hive body (see FIG. 6) has a small drawer in it, which can be removed.

The thickness of the hive walls can be larger or smaller depending on the lowest expected temperature in the region where it will be used.

A conceptual shape for an access port (FIG. 1, item D1) and a cover for this opening (FIG. 1, item D2) allow the beekeeper to introduce substances to the hive as required. Hive body side K in figure one, is permanently attached to the bottom board (FIG. 1, item L).

Referring to FIG. 1:

Side J is fastened to sides K, H and E. Side G is attached to side J with hinges, items C. Side M is fastened to sides H, E and bottom board L. Side F is attached to side M by hinges C.

Thus having described the beehive, what I claim as new is:

1. Two of the hive's sides (see FIG. 1, items F and G) are connected by hinges (see FIG. 1, items C). (independent)

2. The hive body (see FIGS. 1 and 1A) allows the beekeeper have access to any frame within the hive without having to apply a force greater than that necessary to lift either of the two, hinged sides. (dependent on claim 1)

3. The beehive frames (see FIG. 2) each have six sides. (independent)

4. The length of the sides (see FIG. 2) designated as H, of each beehive frame are equal. (independent)

5. Each of the beehive frames' individual sides are attached to each other at a 60±2 degree angle. (see FIG. 2) (independent)

6. The hive has a small drawer built into the rear of the hive. (see FIG. 6) (independent)

7. The beehive frames are supported from below. (FIG. 1, items A) (independent)
